(19) United States
(12) Patent Application Publication
(10) Pub. No.: US 2019/0344279 A1
(43) Pub. Date: Nov. 14, 2019

(54) ANALYZER FOR AQUEOUS MEDIA

(71) Applicant: Xylem Industries S.à.r.l., SENNINGERBERG (LU)

(72) Inventors: Manfred Rosenauer, Peiting (DE); Rudolf Schuhmacher, Peißenberg (DE); Frank Honold, Polling (DE)

(73) Assignee: Xylem Industries S.à.r.l., SENNINGERBERG (LU)

(21) Appl. No.: 16/405,870

(22) Filed: May 7, 2019

(30) Foreign Application Priority Data
May 11, 2018 (EP) 18 171 856.0-1001

(51) Int. Cl. B01L 3/00; G01N 21/25; G01N 21/27; G01N 27/02; B01L 7/00; G01N 27/416

(52) U.S. Cl. CPC B01L 3/52; G01N 21/251; G01N 21/272; G01N 27/02; B01L 7/00; G01N 27/416; B01L 2300/12; B01L 2200/04; B01L 2300/0663; B01L 2300/123; B01L 2300/1894; B01L 2200/026; B01L 2200/0689

(57) ABSTRACT

An analysis device for aqueous media which includes a detection unit and a reagent container, which is detachably connectable to the detection unit, for adding reagents to the aqueous medium, which react with the substances to be detected in the aqueous medium to form products that can be detected analytically by the detection unit, wherein the reagent container is designed so that the passage and/or the discharge of age-relevant substances is prevented or reduced.

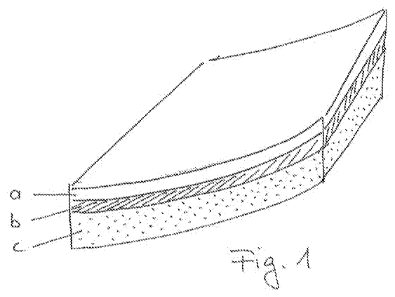

### DESCRIPTION

The present invention relates to an analysis device for aqueous media, comprising a detection unit and a reagent container, which is detachably connectable to the detection unit, for adding reagents to the aqueous medium, which react with the substances to be detected in the aqueous medium to form products that are analytically detectable by the detection unit.

Such analysis devices perform chemical analyses, whereby individual analyses, but also tests may be performed, preferably automatically, at defined time intervals. For this purpose, liquid medium is introduced into the analysis device, in particular, fed to and discharged again from the analysis device via supply and discharge lines. These may be analysis apparatuses, which are designed as a stand-alone device, and which accommodate the detection unit as well as additional units and the reagent container in a housing.

Such devices are often used for monitoring various media or processes, for example, in process engineering operations in the chemical industry for producing substances, but also for controlling cooling waters and in water engineering systems, whether in the treatment or monitoring of drinking water or in sewage treatment plants for controlling and/or regulating processes in wastewater treatment. It is provided here that different substances or groups of substances are detected by measurement, i.e., both qualitatively and alternatively or additionally quantitatively, and the result of the measurement is used for monitoring and/or control purposes. In this case, corresponding analysis devices may be used both for the determination of individual substances, such as, for example, ammonium, or of substance groups, such as, for example, of the total nitrogen content.

The analysis device in this case comprises a detection unit which is connected to at least one reagent container. The reagents react with substances in the aqueous solution in order to convert the substances to a measurable size. Thus, it is known, for example, to convert ortho-phosphate, linear polyphosphates, cyclic polyphosphates, organically bound phosphorus to ortho-phosphate in such a way that it then forms a yellow dye with a molybdate-containing reagent, which can be measured. This can be done for example via optical methods or via electrochemical principles, processes or methods. The optical methods are based, for example, on colorimetry or photometry. However, other known measuring methods are possible. Reagents but also standard, cleaning or calibration solutions are accommodated in the reagent container and are hereby connected to the device, in particular mechanically and with regard to the fluid passages.

Methods from the field of potentiometry, amperometry or conductometry, for example, may be used as electrochemical methods. Alternative methods known in the art are conceivable. The digestion and detection processes in the detection unit require reagents with which the relevant reactions described may be carried out. The reagents in this case are stored in reagent containers. Furthermore, calibration and/or cleaning solutions are required to support the operation, which are also stored and provided in such containers and these are also to be referred to here as a reagent containers.

The disadvantage here is that there is a risk that the reagents age, which may manifest itself in the fact that the reagents, which may be in the form of solids, liquids or gases, change in their composition, their nature or their concentration. As a result, their use can be limited in time.

In the prior art, for example, it is known to provide cooling of the reagents to extend the time of use.

If appropriate analysis devices are used in laboratories, cooling of the reagents can take place in separate cooling devices. However, if such analysis devices are not used in laboratories, but in plants such as in those in the chemical industry or in the field of sewage treatment plants, then an additional cooling there means additional equipment is required. In addition, there is always an additional energy requirement which is disadvantageous. Furthermore, it is known to protect the reagents against aging by storing them separately for as long as possible and not yet preparing the reagents. The disadvantage here is that then additional services are necessary and the reagents cannot be stored in a usable form in the containers and are not available for use as a commodity ready for use.

It is therefore an object of the present invention to provide an analysis device in which the period of use of reagents is prolonged.

The object is achieved by an analysis device having the features of claim 1, in which the at least one reagent container is designed so that the passage and/or the delivery of age-relevant substances is prevented or reduced. As aging-relevant substances, both gases, such as CO₂ or oxygen, which diffuse into the reagent, as well as gases that diffuse out of the reagent, such as water vapor, may be relevant. Other relevant aging process-inducing substances may be, for example, metals that promote the decomposition of unstable reagents.

The analysis device is preferably formed in a housing, in particular, as a stand-alone device. An element for connecting or, in particular, also holding or receiving the reagent container is provided in the analysis device in order to bring or introduce reagents into contact with a medium.

It can be provided that phosphorus molybdenum blue is used in the determination of orthophosphate according to the so-called blue method. To produce this dye, a reducing agent is needed. If oxygen enters the reagent container, either directly through an orifice used, for example, to withdraw the reagent by means of a tube or the like, or by diffusion through the container wall, the reducing agent serving as a reagent is deactivated over time. In turn, the escape of water vapor may lead to a change in concentration, if water has been used as a solvent, and this water diffuses via the vapor pressure in gaseous form through the vessel wall to the outside. The proportion of the reagent mixture is therefore reduced and the concentration of the other reagent ingredients increased. An alternative possibility of aging is, for example, in the influx of CO₂, which may cause a change in pH. The setting of the correct pH also represents an important feature for a low aging of the reagents.

The term reagents is to be understood here preferably broadly and should also include standard solutions, calibration solutions or cleaning solutions or the like, which are provided and connected via corresponding containers in the device. Standard solutions in this case are solutions having a defined content of the substances to be measured, which may be used to calibrate the analysis device. The aforementioned solutions are used in the same way in the analysis device and, in particular, are also connected in the respective container to the device.

Further alternative measures may be the separate storage of reagent components.

According to a first embodiment, it may be provided that the reagent container, which may contain one or multiple reagents, is designed as a cartridge or bag. In this case, it represents a replaceable component in the analysis device. Thus, the user of the analysis device may acquire the reagents ready for use in the bag or in the cartridge, and may connect them directly to his/her analysis device, which includes connection elements or removal devices provided for this purpose, both mechanical in nature and for the material flow. It may be provided that a receiving unit is provided for the reagent container, which implements a mechanical support simultaneously with a fluidic connection. The mechanical support may, in particular, be non-positive or positive, in particular, a latching connection, by means of which the reagent container is held.

The reagents in the reagent container in this case are ready for use. The reagent container particularly preferably consists of or comprises a plastic film material, wherein the plastic film material is preferably constructed in multiple layers. Thus, for example, three-layer composite films are conceivable, which consist either exclusively of plastic materials, or have a metallized layer. This can be applied in conventional methods, such as sputtering, etc. An aluminum composite film made of PET/Alu and PE is conceivable, for example, wherein the aluminum layer is embedded between the two plastic layers. Such a layer may exhibit a high tear strength. However, other metals, such as gold or combinations of different metals, as well as various plastics, such as polyamides, polyethylene and polyethylene terephthalate, are also conceivable. The layer sequence may vary and, in particular, although less preferably, the metallized layer may be provided as the outer layer. Metal-free films are likewise conceivable and are the subject matter of a preferred specific embodiment. According to one exemplary embodiment, however, single-layered film materials may also be preferred, wherein PET in particular has only a low permeability for CO₂ or polyamide for oxygen. If the outside of the plastic film material is free of metallic coating, but at the same time is designed to prevent or significantly reduce migration processes of the metal, or there is no metal provided regardless in the reagent container, this may offer advantages in the use of certain reagents. When using a Berthelot reaction to determine ammonium levels, for example, a reagent providing chlorine may be used. For this purpose, hypochlorite is usually used which, however, is unstable and may disintegrate. An example of such a process is the equation

2 OCl⁻→2 Cl⁻+O₂.

Such decompositions are catalyzed, for example, by impurities or low concentrations of metals, metal oxides and also of other substances. For example, the decomposition of hypochlorite is promoted by iron, nickel or oxides thereof. Because both the reagents, as well as the reagent containers are free of such substances and migration of such substances is prevented, the aging resulting from the decomposition may be reduced or even prevented.

It is particularly preferred in this case, if other elements are also used, such as removal devices, shut-off devices. In this case, it is also particularly preferred if the production devices for the containers and also for the solutions and reagents are free of such decomposition-promoting substances, so that no micro-traces are carried into the reagent.

It is particularly preferred that a metallic coating, if provided, is designed gas-tight or with at least reduced gas penetration. In this case, “gas-tight” is to be understood as preventing gas penetration by 80%, in particular by 90% and more particularly by 95%, compared to the same structure without a metallic coating. The term “gas-penetration-preventing” is to be understood as a reduction by at least 40%, preferably by at least 50%, more preferably by at least 60% and more preferably by at least 70% compared to a design of the reagent container without this coating.

The detection device may, in particular, be an optical and/or electrochemical detection device. In this case, the methods known in the art, such as colorimetry or photometry and potentiometry, amperometry or conductometry, as well as other known methods come under consideration. In addition, it may additionally be provided that the analysis device and, in particular, the detection device and, more particularly, the reagent container have a cooling. With additional cooling, it is possible to reduce both a decomposition rate and a diffusion rate and the reaction rate of oxidation.

Furthermore, it is likewise conceivable to provide different reagents separately in corresponding reagent containers and to mix them only in an additional reaction chamber, which is connected downstream from the reagent containers, and only then to contact the reagent with the aqueous medium. Alternatively, the aqueous medium can also be admixed in the reaction chamber, wherein the order is also interchangeable.

Further advantages and features of the invention will become apparent from the remaining application documents, in particular, the following description of the figures.

The single figure shows a reagent container, which is formed in the present case from a multilayer plastic film material, which has been prepared, for example, in a plastic blow molding process. Furthermore, all other conventional methods for producing multilayer plastic film laminates and, in particular, for producing containers from such laminates may also be used for the present invention. The wall of the reagent container in this case consists of a three-layer structure, wherein the two outer sides are formed by a plastic 1 and a plastic 2, here for example PET and PE, wherein the PE layer is directed to the container interior and an aluminum layer has been applied to one of the layers, PE or before that PET. The full-area metallization prevents or at least significantly reduces the penetration of gases through the container wall, as a result of which the aging of the reagents situated in the container may be influenced so that it is slowed down or reduced.

1-8. (canceled)

9. An analysis device for aqueous media, the analysis device comprising:
a detection unit; and
at least one reagent container for reagents, standard solutions or cleaning solutions, wherein
said at least one reagent container is detachably connectable to the detection unit, for adding the reagents, standard solutions or cleaning solutions to the aqueous medium, which react with substances to be detected in the aqueous medium to form products that may be detected analytically by the detection unit, and
the reagent container is designed so that the passage and/or the discharge of said substances is prevented or reduced.

10. The analysis device according to claim 9, wherein
the reagent container is designed as a cartridge or bag.

11. The analysis device according to claim 9, wherein
the reagent container comprises a plastic film material.

12. The analysis device according to claim 11, wherein
the plastic film material is designed in multiple plastic layers, and
one of the multiple plastic layers has a metallic coating and the two outer sides of the plastic film material are free of metallic coating.

13. The analysis device according to claim 11, wherein
the metallic coating is gas-tight.

14. The analysis device according to claim 12, wherein
the metallic coating is gas-tight.

15. The analysis device according to claim 9, wherein
the detection device is an optical and/or electrochemical detection device.

16. The analysis device according to claim 9, wherein
the analysis device, the detection device and/or the reagent container has a cooling function.

17. The analysis device according to claim 9, wherein
the analysis device has a receiving unit for the releasable mechanical and fluidic connection of the reagent container.

18. The analysis device according to claim 10, wherein
the reagent container comprises a plastic film material.

19. The analysis device according to claim 11, wherein
the plastic film material is designed in multiple plastic layers.

20. The analysis device according to claim 18, wherein
the plastic film material is designed in multiple plastic layers.

21. The analysis device according to claim 18, wherein
the plastic film material is designed in multiple plastic layers, and
one of the multiple plastic layers has a metallic coating and the two outer sides of the plastic film material are free of metallic coating.

22. The analysis device according to claim 11, wherein
the plastic film material is designed in multiple plastic layers, and
one of the multiple plastic layers has a metallic coating.

23. The analysis device according to claim 19, wherein
the plastic film material is designed in multiple plastic layers, and
one of the multiple plastic layers has a metallic coating.

24. The analysis device according to claim 20, wherein
the plastic film material is designed in multiple plastic layers, and
one of the multiple plastic layers has a metallic coating.

25. The analysis device according to claim 9, wherein
the analysis device, the detection device and/or the reagent container has a cooling mechanism.

26. The analysis device according to claim 9, wherein
the analysis device, the detection device and/or the reagent container has a cooling unit for cooling.

27. The analysis device according to claim 9, wherein
the analysis device, the detection device and/or the reagent container has a cooling unit configured to provide cooling.
